(19) United States
(12) Patent Application Publication
(10) Pub. No.: US 2008/0072052 A1
(43) Pub. Date: Mar. 20, 2008

(54) Authentication server, image formation apparatus, image formation authenticating system and computer readable storage medium storing program

(75) Inventor: Akira Suzuki, Atsugi-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA BUSINESS TECHNOLOGIES, INC.

(21) Appl. No.: 11/639,285

(22) Filed: Dec. 15, 2006

(30) Foreign Application Priority Data
Aug. 17, 2006 (JP) 2006-222594

(51) Int. Cl. H04L 9/00

(52) U.S. Cl. 713/176

(57) ABSTRACT

An authentication server communicationally connected to an image formation apparatus through a communication network. The server includes: a registration information reception unit to receive registration information including individual information assigned peculiarly to the image formation apparatus and installation information from the image formation apparatus; a security information generation unit to generate security certification information based on the registration information received by the registration information reception unit; and a security information transmission unit to transmit the security certification information generated by the security information generation unit to the image formation apparatus.

### CROSS-REFERENCE TO RELATED APPLICATION

The present U.S. patent application claims a priority under the Paris Convention of Japanese patent application No. 2006-222594 filed on Aug. 17, 2006, and shall be a basis of correction of an incorrect translation.

### BACKGROUND OF THE INVENTION

1. Field of the Invention

The present invention relates to an authentication server, an image formation apparatus, an image formation authenticating system and a computer readable storage medium storing a program.

2. Related Art

There has been spreading a mobile office which makes it possible for a person to access an internal office system from a remote place on the outside of the office to perform a work as if the person is in the office because network infrastructures have been enriched in recent years. For example, a user remotely accesses the internal office system with a terminal device such as a notebook computer to perform the editing of a file in the internal office system and the like, and transfers the file from the internal office system to an adjacent image formation apparatus through a network to make the image formation apparatus form an image.

Moreover, improvement of security has been emphasized also in the field of image formation apparatus such as a copier, a printer, a multifunction peripheral (MFP) and the like from the viewpoints of information management of a company and the like, and various functions for enhancing the security (hereinafter referred to as “security functions”) have been proposed. As examples of the functions, there are an encrypted communication function of performing encrypted communication with a terminal device on a communication network, a user authentication function of performing authentication of a user using an image formation apparatus by inputting a password or the like, an encrypted saving function of performing encryption at the time of storing data into an internal storage device, a data deletion function of deleting the stored data completely after image formation, and the like.

By performing such an image formation using an image formation apparatus equipped with such various security functions, the leakage of information and the like can be prevented to maintain confidentiality. Consequently, it is desirable to perform an image formation of data the confidentiality of which is emphasized, such as the data of an internal office document, with the image formation apparatus equipped with the security functions at the time of performing the image formation of the data, and the following technique is known as a related technique.

That is, there is known a document server (print management server) (refer to JP-2002-259108A) that collates a printer of a specified printing destination with a list of previously registered safe printers (image formation apparatus) and performs data transmission after performing further authentication based on a public key certificate including an information indicating a class of safety that is transmitted from the printer when the printer agrees with one of the listed printers.

Generally, the public key certificate described in JP-2002-259108A is issued by a predetermined certificate authority. At present, a certificate authority used generally is one which issues a digital certificate for a terminal device such as a server, a personal computer or the like. Accordingly, when setting up an image formation apparatus, a user is required to receive an issue of digital certificate by conducting complicated proceedings to the certificate authority previously.

### SUMMARY

The present invention was made in consideration of the problems mentioned above. It is an object of the present invention to make it possible to reduce the complicated proceedings for guarantee of the safety of an image formation apparatus.

In order to solve the problem, according to an aspect of the invention, the authentication server communicationally connected to an image formation apparatus through a communication network, comprises:

a registration information reception unit to receive registration information including individual information assigned peculiarly to the image formation apparatus and installation information from the image formation apparatus;

a security information generation unit to generate security certification information based on the registration information received by the registration information reception unit; and

a security information transmission unit to transmit the security certification information generated by the security information generation unit to the image formation apparatus.

Preferably, the authentication server of further comprises a judgment request unit to request judgment of validity pertaining to at least a part of information included in the registration information from a manufacturer's server of the image formation apparatus, wherein the security information generation unit generates the security certification information when the validity of at least a part of information included in the registration information can be obtained as a result of the request of judgment by the judgment request unit.

Preferably, the security information generation unit calculates a hash value based on the registration information to generate the security certification information including the hash value.

Preferably, the security information generation unit generates the security certification information including manufacturer information of the image formation apparatus.

Preferably, the installation information includes positional information of the image formation apparatus on the communication network.

Preferably, the individual information includes a manufacturing number of the image formation apparatus.

Preferably, the individual information includes key information issued by a manufacturer's server of the image formation apparatus.

### BRIEF DESCRIPTION OF THE DRAWINGS

FIG. 1 is a block diagram showing an example of the system configuration of a print authentication system;

FIG. 2 is a block diagram showing an example of the functional configuration of a printing apparatus;

FIG. 3 is a diagram showing an example of the data configuration of the storage unit of the printing apparatus;

FIGS. 4A, 4B, 4C and 4D are diagrams showing examples of the data configurations of apparatus' own peculiar information, installation place information, a security certificate and user information;

FIGS. 5A and 5B are diagrams showing examples of the data configuration of security status information;

FIG. 6 is a block diagram showing an example of the functional configuration of a printing server;

FIG. 7 is a block diagram showing an example of the functional configuration of an authentication server;

FIG. 8 is a flow chart for describing the concrete operation of the printing apparatus;

FIG. 9 is a flow chart for describing the concrete operation of the printing server;

FIG. 10 is a flow chart for describing the concrete operation of the authentication server;

FIGS. 11A and 11B are diagrams showing an example of the sequence flow of the print authentication system; and

FIGS. 12A, 12B and 12C are diagrams showing examples of display screens of the printing apparatus.

### DETAILED DESCRIPTION OF THE PREFERRED EMBODIMENT

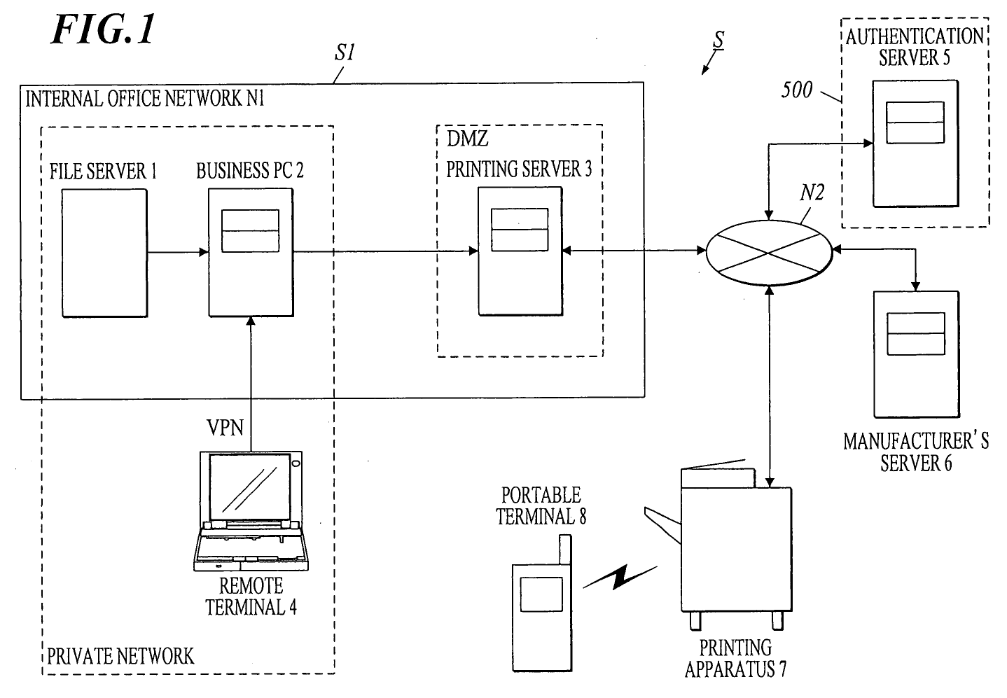

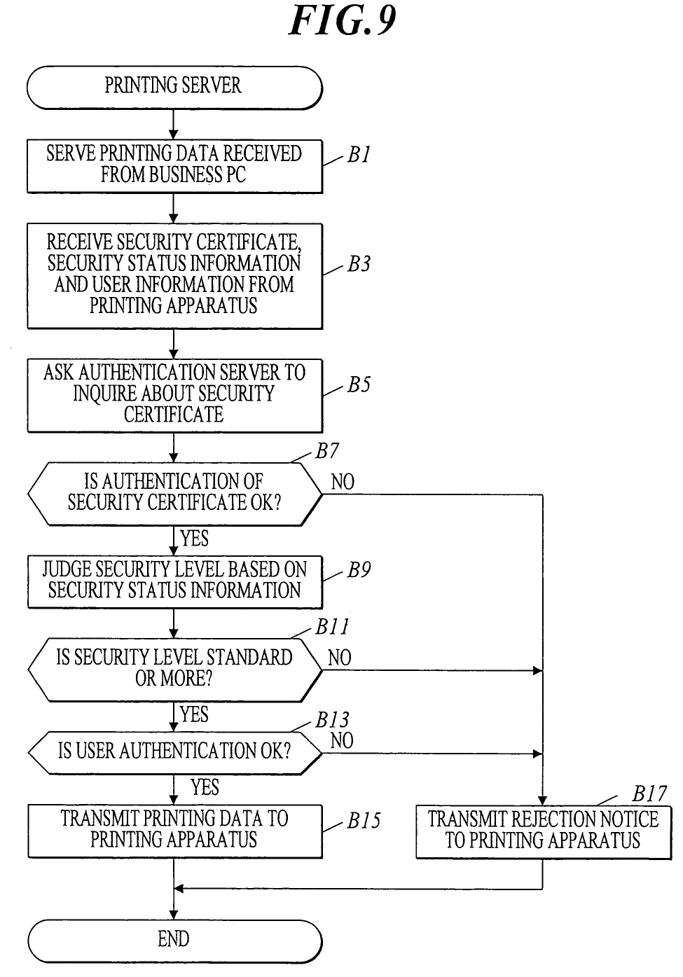

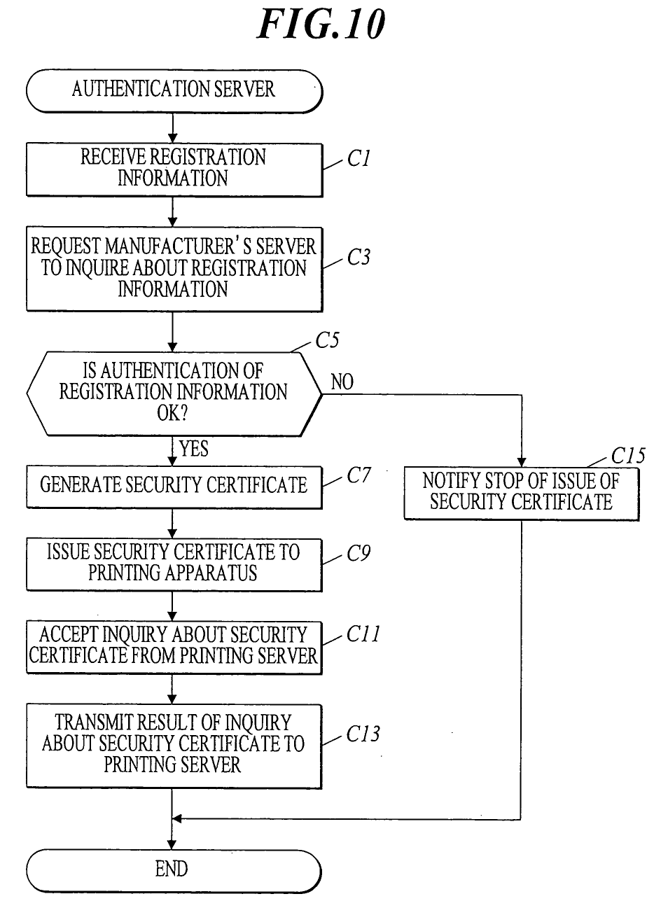

Hereinafter, an embodiment of an image formation authenticating system according to the present invention in case of being applied to a print authentication system S of FIG. 1 is minutely described with reference to FIGS. 1-12C. In addition, although the description is given on the supposition of applying the present invention to a printing apparatus 7, which is a multifunction peripheral (MFP), in the present embodiment, the present invention may be applied to the other image formation apparatus such as a printer, a copier, a facsimile and the like.

First, a description is given to the outline of the print authentication system S shown in FIG. 1. As shown in FIG. 1, the print authentication system S is composed of an internal office system S1, a remote terminal 4, an authentication server 5, a manufacturer's server 6 and a printing apparatus 7, all of which are communicationally connected with one another through a public network (communication network) N2.

Moreover, the internal office system S1 is composed of a file server 1 to store and manage file data for each user, a business personal computer (PC) 2 and a printing server 3 as a print management server, all of which are communicationally connected with one another through an internal office network (communication network) N1.

The printing server 3 is a server to perform the storage of data to be printed and the scheduling of printing, and the printing server 3 transmits printing data to a printing apparatus (not shown) in the internal office system S1 or the printing apparatus 7 on the public network N2 in accordance with an instruction of a user. Moreover, the printing server 3 is disposed in a demilitarized zone (DMZ), and is opened to the public into the public network N2, which is a global network. Consequently, it is possible to access the printing server 3 from a predetermined terminal device.

The remote terminal 4 is a terminal device capable of remotely accessing the internal office system S1 by constructing a virtual private network (VPN) between the remote terminal 4 and the business PC 2, and is composed of a personal computer, a personal digital (data) assistant (PDA) and the like.

The user remotely accesses the internal office system S1 from the remote terminal 4 on the outside of the internal office network N1 via the VPN, and can participate in the private network in the internal office system S1. Then, it becomes possible to operate the business PC 2 as if the user is in the internal office system S1, although the user is actually on the outside of the company, by accessing the business PC 2 from the remote terminal 4 on the outside of the company using the business PC 2 as a remotely accessing server.

The user performs the editing of the file data stored and managed by the file server 1 after downloading the file data into the business PC 2 by operating the remote terminal 4. Moreover, when the user performs the printing of the file data, the user operates the remote terminal 4 to transfer the printing data of the file from the business PC 2 to the printing server 3.

Hereupon, the printing data is the data including job information and the image data of the vector format or the bit map format. A unit of a series of operation performed by the printing apparatus 7 is referred to as the “job.” The job information is the set information indicating the contents of a job, such as the number of pages, the number of copies, a paper size, an output medium and the like, and is described in the Job Definition Format (JDF) for example. The job information is set based on a setting operation of the user or a default.

When the user inputs the network address (e.g. an IP address) of the printing server 3 and the user information such as a user ID, a password and the like by a manual input or data communication from a portable terminal 8 into the printing apparatus 7 on the outside of the internal office system S1 which printing apparatus 7 is connected to the public network N2, predetermined authentication processing is performed between the printing apparatus 7 and the printing server 3. Then, when the authentication processing is effected, printing data is downloaded from the printing server 3, and printing (image formation) by the printing apparatus 7 is executed.

However, it is apprehended that the printing data is eavesdropped on without encrypting the communication path between the printing server 3 and the printing apparatus 7. Moreover, there is the possibility of the leakage of printing data if the printing data is left to be stored in the printing apparatus 7 after the downloading of the printing data.

Accordingly, the printing apparatus 7 is provided with the security functions for preventing the leakage of the data thereof. As examples of the security functions, there are an encrypted communication function, an encrypted saving function, a user authentication function and a data deletion function.

The encrypted communication function is a function of constructing an encrypted path between the printing apparatus 7 and the printing server 3 and encrypting printing data by a predetermined encryption system (e.g. a Hyper Text Transfer Protocol over SSL (HTTPS) system) to perform transmission and reception. The encrypted saving function is the function of temporarily storing printing data after encrypting the printing data by a predetermined encryption system (e.g. Advanced Encryption Standard (AES) system) at the time of storing the downloaded printing data into a storage medium.

Moreover, the user authentication function is a function of requesting the input of user information to perform user authentication at the time of downloading printing data from the printing server 3. The data deletion function is a function of completely deleting the printing data stored in a storage medium after printing. Whether the operation of the security functions is made to be effective or not is set at the time of initialization, user setting or the like.

The printing server 3 obtains the operation state of the security functions from the printing apparatus 7 before the transmission of printing data, and then judges the security level of the printing apparatus 7 based on the obtained operation state. Then, the printing server 3 transmits the printing data only when the printing server 3 judges that the security level is a predetermined level or more.

Moreover, the authentication server 5 included in the print authentication system S is a server to issue a security certificate to the printing apparatus 7, and is managed by a printing certificate authority 500. The security certificate is the data to certify that a public key for analyzing a digital signature is authentic to guarantee the identity of the printing apparatus 7.

When the printing apparatus 7 is installed, the information of the manufacturer, the manufacturing number, the network address and the like of the printing apparatus 7 are transferred to the authentication server 5. At this time, the authentication server 5 produces a security certificate based on the transferred data, and performs digital signature using a secret key peculiar to the printing certificate authority 500. After that, the authentication server 5 transmits the security certificate to the printing apparatus 7. As the production method of the security certificate, it is possible to use a standard method prescribed by the ITU-T X.509 international standard or the like.

When the printing apparatus 7 is the one that satisfies the security level and has received the issue of a just security certificate, the printing server 3 relies on the printing apparatus 7 as the one the safety of which is guaranteed, and performs the transmission of printing data. Consequently, it becomes unnecessary to previously register the printing apparatus 7 on the outside of the internal office system S1 into the printing server 3.

Moreover, the manufacturer's server 6 is a server managed by the maker who manufactured the printing apparatus 7. The authentication server 5 requests the inquiry about the information of a manufacturer, the manufacturing number and the like that have been transmitted from the printing apparatus 7 from the manufacturer's server 6 at the time of producing the security certificate. When the information of the manufacturer, the manufacturing number and the like are right, the manufacturer's server 6 produces the security certificate to issues the produced security certificate to the printing apparatus 7 in response to the request of the inquiry.

The printing apparatus 7 stores the security certificate issued from the authentication server 5 in advance, and transmits the stored security certificate to the printing server 3 before the download of the printing data. The printing server 3 transfers the security certificate transmitted from the printing apparatus 7 to the authentication server 5, and requests the inquiry about whether the security certificate is just one or not. By the inquiry about the security certificate, the confirmation of the identity of the printing apparatus 7 can be performed.

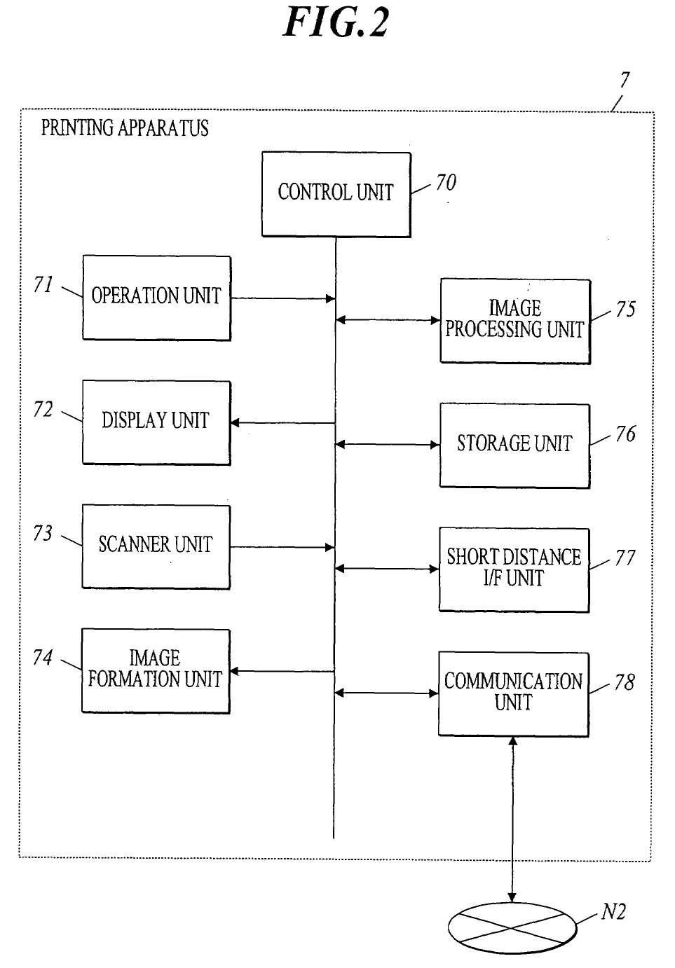

Next, a description is given to the functional configuration of the printing apparatus 7 with reference to FIGS. 2-5B. FIG. 2 is a block diagram showing an example of the functional configuration of the printing apparatus 7. According to FIG. 2, the printing apparatus 7 is composed of a control unit 70, an operation unit 71, a display unit 72, a scanner unit 73, an image formation unit 74, an image processing unit 75, a storage unit 76, a short distance I/F unit 77 and a communication unit 78.

The control unit 70 is composed of a central processing unit (CPU), a read only memory (ROM), a random access memory (RAM) and the like, and controls an instruction to each function unit constituting the printing apparatus 7 and data communications among the function units. To put it more concretely, the CPU reads a program from the ROM based on an operation signal output from the operation unit 71, and performs the processing in accordance with the read program. Then, the CPU makes the RAM temporarily store the processing result, and makes the display unit 72 display the processing result.

The operation unit 71 is composed of a various key groups such as a start key, a cancel key, ten keys, cursor keys and the like, a touch panel or the like, and outputs operation signals such as a depression signal corresponding to a depressed key, a position signal corresponding to a contacted position of the touch panel, and the like to the control unit 70.

The display unit 72 is composed of a cathode ray tube (CRT), a liquid crystal display (LCD) or the like. The display unit 72 displays various setting screens, image states, the operation state of each function, and the like to output them based on the instructions and control from the control unit 70. The control unit 70 makes the display unit 72 display various setting screens, and produces job information based on the setting contents selected and settled by the operation of the operation unit 71 to store the produced job information into the storage unit 76.

The scanner unit 73 is equipped with a platen glass, a charge coupled device (CCD) and a light source, and reads an original optically to generate image data. To put it concretely, the scanner unit 73 illuminates an original placed on an auto document feeder (ADF) unit (automatic original feeding apparatus) with the light from the light source, and scans the original. The scanner unit 73 provides an image of the reflected light of the scanning light and performs the photoelectric conversion with the CCD. Thereby, the scanner unit 73 reads the image of the original, and generates the image data of the image to output the generated image data to the image processing unit 75.

The image formation unit 74 is composed of a laser diode (LD), a photosensitive drum, a charging device, a developing device, a transfer unit, a fixing device, feed rollers to convey a recording medium along a conveyance path, and the like. The image formation unit 74 performs the image formation of an image based on image data on a recording medium.

To put it concretely, the image formation unit 74 performs the paper feeding of a recording medium having a predetermined size and a predetermined direction based on an instruction of the image processing unit 75 to convey the recording medium onto the conveyance path. Then, the image formation unit 74 makes the surface of the photosensitive drum be charged with the charging device. Then, the image formation unit 74 irradiates the surface of the photosensitive drum with a laser beam based on a pulse width modulation (PWM) signal input from the image processing unit 75, and thereby forms an electrostatic latent image on the surface of the photosensitive drum. Next, the image formation unit 74 adheres toner to a region including the electrostatic latent image on the surface of the photosensitive drum with the developing device, and the transfer unit transfers toner onto the conveyed recording medium to form an image. After the image formation unit 74 has fixed the transferred image with the fixing device, the image formation unit 74 ejects the recording medium.

The image processing unit 75 is composed of a multiprocessor or the like, and performs various kinds of image processing to image data. To put it concretely, the image processing unit 75 performs correction processing, such as shading correction, luminance density conversion, density γ conversion, inclination correction and the like, to the image data generated by the scanner unit 73. After that, the image processing unit 75 compresses the corrected image data, and temporarily stores the compressed image data into an image memory 770 in the storage unit 76. Then, when the image processing unit 75 is instructed to read the image by the control unit 70, the image processing unit 75 expands the compressed image data.

When the image processing unit 75 is instructed to start printing by the control unit 70, the image processing unit 75 reads non-compressed image data by the page, and performs the expansion and the contraction, the turnabout and the like of the image data based on the job information stored in the storage unit 76. Moreover, after the image processing unit 75 has performed the image processing such as the γ correction processing, screen processing and the like, the image processing unit 75 generates a PWM signal based on the image data to output the generated PWM signal to the image formation unit 74.

The short distance I/F unit 77 is composed of an antenna, a transmission circuit, a reception circuit and the like, and performs short distance wireless communication with the portable terminal 8 based on the control of the control unit 70. For example, a transmission system of infrared rays, Bluetooth (registered trademark) or the like may be suitably adopted as the wireless transmission system of the short distance wireless communication.

When it is possible to perform data communication with the short distance I/F unit of the portable terminal 8 at the time of inputting user information and a network address, the control unit 70 obtains the user information and the network address both of which are transmitted from the portable terminal 8 through the short distance I/F unit 77.

The communication unit 78 is a function unit for performing the data communication with the other external equipment such as the printing server 3 and the authentication server 5 through a communication network such as the public network N2, and is composed of a modem, a LAN interface or the like.

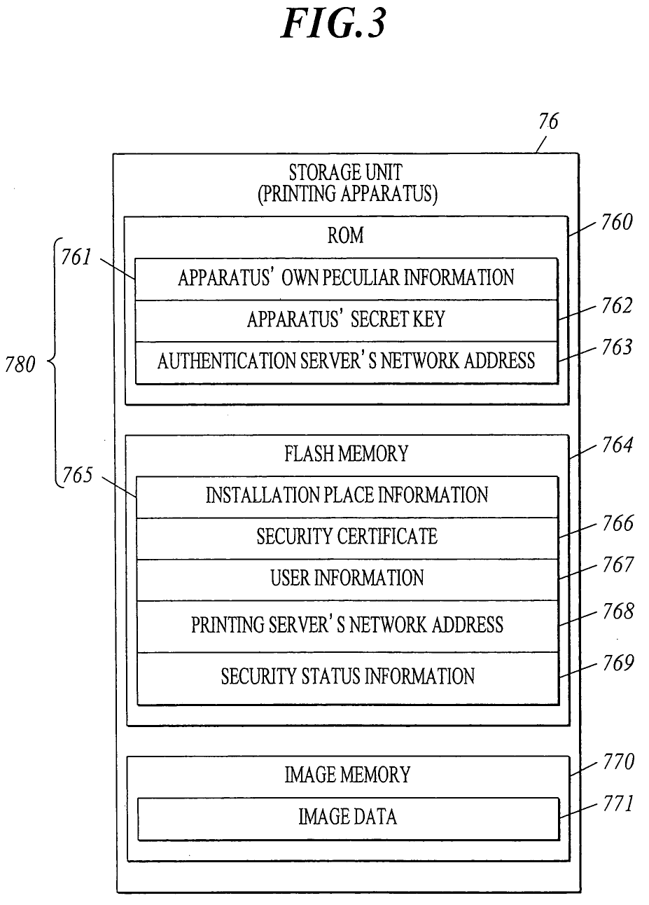

The storage unit 76 is composed of a ROM 760, a flash memory 764 and the image memory 770, as shown in FIG. 3. The ROM 760 is a memory region only for reading data, and stores an apparatus' own peculiar information 761, an apparatus' secret key 762 issued by the manufacturing company of the printing apparatus 7, and a network address 763 as the connection destination information to the authentication server 5, as shown in FIG. 3.

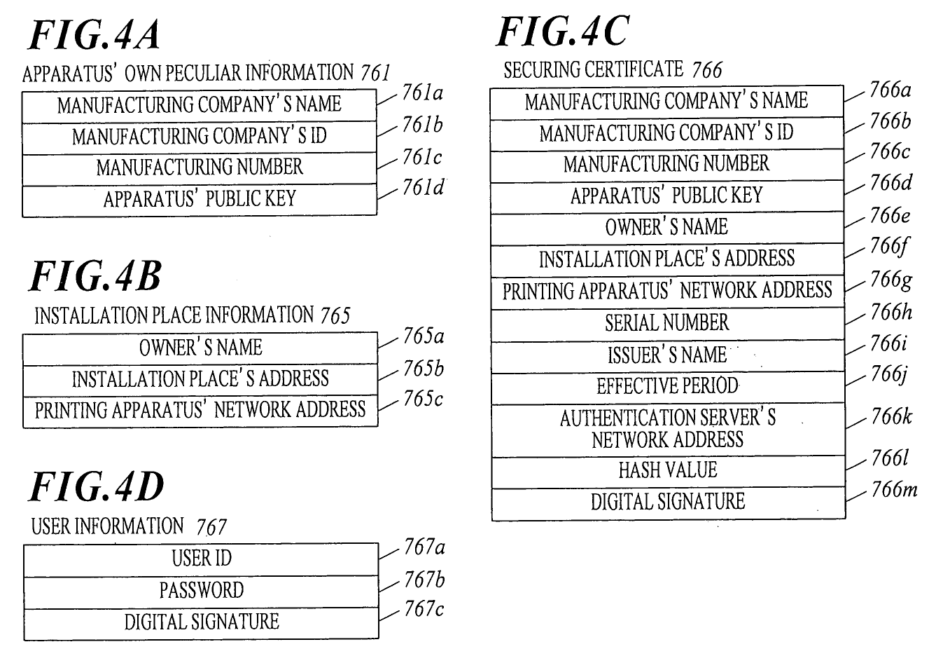

The apparatus' own peculiar information 761 is the individual information assigned peculiarly to the printing apparatus 7 in advance, and is the data including a manufacturing company's name 761a, a manufacturing company's ID 761b, a unique manufacturing number 761c assigned peculiarly to each printing apparatus 7, and apparatus' public key 761d issued by the manufacturing company of the printing apparatus 7, as shown in FIG. 4A. The storage of these pieces of the apparatus' own peculiar information 761 written in the ROM 760 is managed by the manufacturer's server 6.

In addition, although the apparatus' own peculiar information 761 has been described to be previously stored in the ROM 760, the apparatus' own peculiar information 761 input by a user's operation may be stored in the flash memory 764 for example. In this case, the information such as the manufacturing company's name 761a, the manufacturing company's ID 761b and the like is managed on the side of the maker, and is suitably issued from the maker.

The flash memory 764 is a memory region from and to which reading and writing data can be performed, respectively, and stores installation place information 765, a security certificate 766, user information 767, the network address 768 of the printing server 3, and security status information 769, as shown in FIG. 3.

The installation place information 765 is the installation information input at the time of the installation of the printing apparatus 7, and is the data including an owner's name 765a, an installation place's address 765b and the network address 765c of the printing apparatus 7, as shown in FIG. 4B.

The control unit 70 accesses the authentication server 5 indicated by the network address 763 through the public network N2, and transmits the apparatus' own peculiar information 761 and the installation place information 765 to the authentication server 5 as registration information 780. In response to the transmission of the registration information 780, the security certificate 766 is transmitted from the authentication server 5. The control unit 70 receives the security certificate 766 transmitted from the authentication server 5, and stores the received security certificate 766 into the flash memory 764.

The security certificate 766 is a digital certificate in order to certify that the printing apparatus 7 is the image formation apparatus having the security functions, and is the data including a manufacturing company's name 766a, a manufacturing company's ID 766b, a manufacturing number 766c, an apparatus' public key 766d, an owner's name 766e, an installation place's address 766f, the network address 766g of the printing apparatus 7, a serial number 766h, an issuer's name 766i, an effective period 766j, the network address 766k of the authentication server 5, a hash value 766l and a digital signature 766m, as shown in FIG. 4C. In addition, the production of the security certificate 766 is performed by a standard method prescribed by the ITU-TX.509 international standard or the like with the authentication server 5, which will be described later, and the description of the method will be described later.

The user information 767 is the data including a user ID 767a, a password 767a and a digital signature 767c, as the example of the data configuration thereof shown in FIG. 4D. The control unit 70 requests the input of the user ID 767a and the password 767b from the user at the time of the reception of printing data 331 from the printing server 3, and obtains the user ID 767a and the password 767b based on an operation signal from the operation unit 71. Then, the control unit 70 generates the digital signature 767c based on the apparatus' secret key 762 stored in the ROM 760, and makes the digital signature 767c be included in the user information 767.

The network address 768 of the printing server 3 is the connection destination information to the printing server 3, which is input by the user, and is used at the time of the access to the printing server 3 through the public network N2. By the access to the external equipment indicated by the network address 768, the security certificate 766, the user information 767 and the security status information 769 are transmitted.

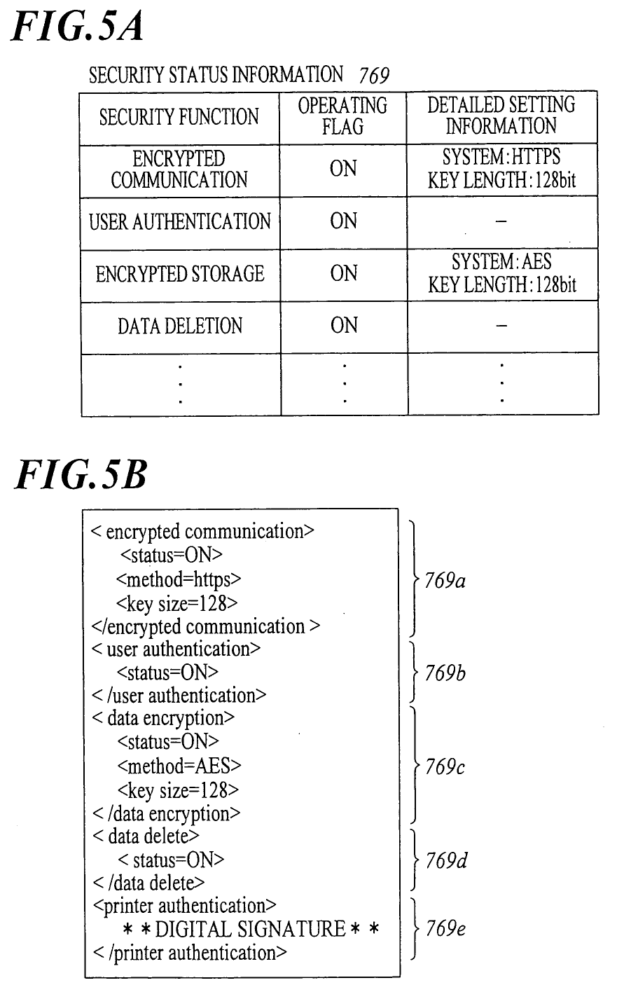

The security status information 769 is the data indicating the operation settings of the various security functions, and is a data table to store an operating flag and detailed setting information to each of the security functions so that they are associated with each other, as shown in FIG. 5A. The security status information 769 is set based on a user's operation and initialization.

The operating flags are flags (ON/OFF) indicating whether the security functions should be operated or not. The detailed setting information is the data indicating the detailed setting contents of each of the security functions. For example, in FIG. 5A, the encrypted communication function is set to operate, and the cipher system and the key length thereof are set to be the HTTPS system and 128 bits, respectively.

FIG. 5B shows a description example of the security status information 769. In the description example of FIG. 5B, a reference numeral 769a denotes the encrypted communication function; a reference numeral 769b denotes the user authentication function; a reference numeral 769c denotes the encrypted storage function; a reference numeral 769d denotes the setting contents of the data deletion function.

Moreover, the security status information 769 includes a digital signature 769e. The control unit 70 produces the digital signature 769e based on the apparatus' secret key 762 at the time of transmitting the security status information 769 to the printing server 3, and adds the digital signature 769e to the security status information 769.

The image memory 770 is composed of a dynamic RAM (DRAM) for example, and includes a compression memory to temporarily store the compressed image data 771, and a page memory to temporarily store the non-compressed image data 771 before printing.

When the control unit 70 downloads the printing data from the printing server 3, the control unit 70 transmits the registration information 780, the security certificate 766 and the security status information 769 to the printing server 3. At this time, the printing data is transmitted only when the printing server 3 has judged the security level of the printing apparatus 7 to be a predetermined level or more based on the transmitted information.

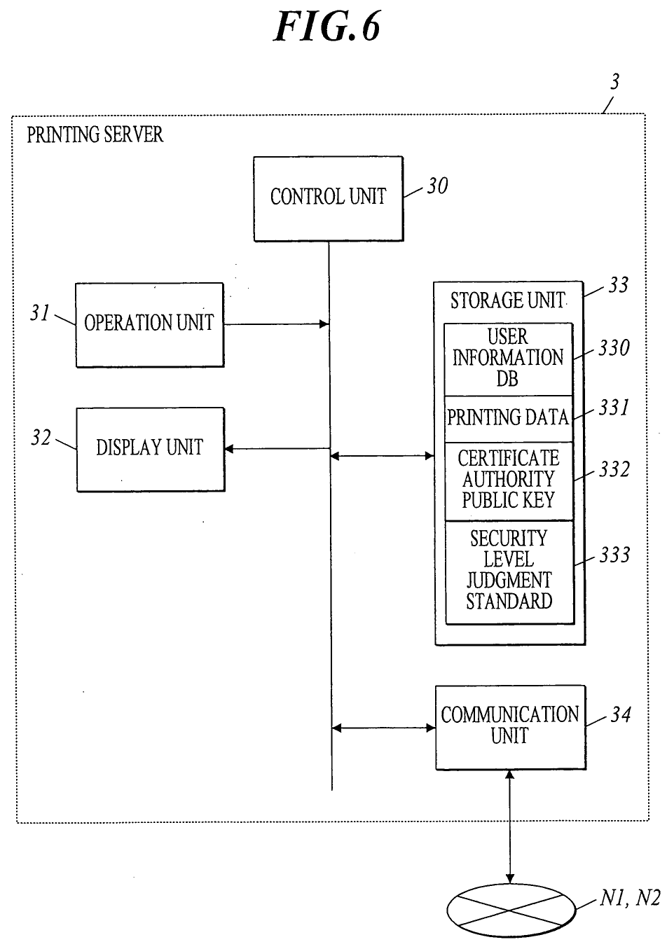

Next, a description is given to the functional configuration of the printing server 3 with reference to FIG. 6. FIG. 6 is a block diagram showing an example of the functional configuration of the printing server 3. According to FIG. 6, the printing server 3 is composed of a control unit 30, an operation unit 31, a display unit 32, a storage unit 33 and a communication unit 34.

The control unit 30 is composed of a CPU, a ROM, a RAM and the like, and controls the instructions to each of the function units constituting the printing server 3, and the data communications among the function units. To put it more concretely, the CPU reads a program from the ROM based on an operation signal output from the operation unit 31, and performs the processing in accordance with the read program. Then, the CPU makes the RAM temporarily store the processing result, and makes the display unit 32 display the processing result.

The operation unit 31 is composed of a keyboard, a mouse and the like, and outputs operation signals such as a depression signal corresponding to a depressed key, a position signal corresponding to a position specified by the mouse, and the like to the control unit 30. The display unit 32 is composed of a CRT, an LCD or the like, and displays various setting screens and image states based on the instructions and the control from the control unit 30.

The communication unit 34 is a function unit for performing the data communication with the other external equipment such as the authentication server 5, the printing apparatus 7 and the like through a communication network such as the public network N2 and the internal office network N1, and is composed of a modem, a LAN interface or the like.

The storage unit 33 is composed of a nonvolatile memory, a hard disk drive (HDD) or the like, and stores various data. According to FIG. 6, the storage unit 33 stores a user information DB 330, the printing data 331, a certificate authority public key 332 and a security level judgment standard 333.

The user information DB 330 is a data base storing the user ID and the password of each user, both of which are associated with each other. The printing data 331 is the data including the job information and the image data, both of which have been described above, and the printing data 331 is produced by the business PC 2 to be transferred in response to a user's printing instruction.

The certificate authority public key 332 is a public key issued by the authentication server 5 in advance. When the security certificate 766 is transmitted from the printing apparatus 7 to the control unit 30, the control unit 30 decodes the security certificate using the certificate authority public key 332, and obtains the apparatus' public key 766d. Then, the control unit 30 performs the decoding and the authentication of the digital signature included in the user information 767 and the security status information 769 using the apparatus' public key 766d.

The security level judgment standard 333 is the standard data of the judgment whether the security functions of the printing apparatus 7 satisfy previously settled conditions or not. To put it concretely, the security level judgment standard 333 is the data including the ON/OFF of operation and the detailed settings of each of the security functions.

The control unit 30 performs user authentication based on whether the user information 767 transmitted from the printing apparatus 7 and the user information stored in the user information DB 330 agree with each other or not. Then, the control unit 30 judges the availability of the transmission of the printing data 331 to the printing apparatus 7 based on the security status information 769 and the security certificate 766 both of which are further transmitted.

To put it concretely, the control unit 30 transfers the received security certificate 766 to the authentication server 5 to request the authentication server 5 to judge whether the security certificate 766 is just or not. Moreover, the control unit 30 judges whether the operating flag and the detailed setting information of the security status information 769 satisfy the previously settled conditions or not.

For example, the control unit 30 judges whether the security status information 769 satisfies the following conditions or not if the security level judgment standard 333 is set to satisfy the conditions: the operating flag of the encrypted communication function is ON, and the encryption system and the key length are the HTTPS system and 128 bits, respectively; and the operating flag of each of the user authentication function and the data deletion function is ON.

When the authentication server 5 judges that the security certificate 766 is just and judges that the security status information 769 satisfies the security level judgment standard 333, the control unit 30 transmits the printing data 331 to the printing apparatus 7.

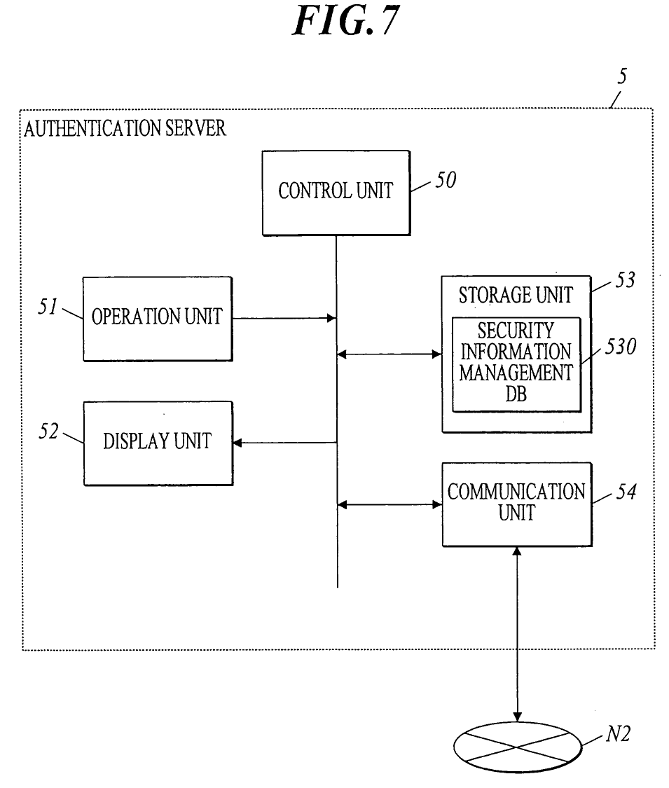

Next, a description is given to the functional configuration of the authentication server 5 with reference to FIG. 7. FIG. 7 is a block diagram showing an example of the functional configuration of the authentication server 5. According to FIG. 7, the authentication server 5 is composed of a control unit 50, an operation unit 51, a display unit 52, a storage unit 53 and a communication unit 54. In addition, because the configuration of each function unit included in the authentication server 5 is almost the same as that of each function unit of the printing server 3, the respects different from those of the function units of the printing server 3 are mainly described.

The storage unit 53 stores a security information management DB 530 as shown in FIG. 7. The security information management DB 530 is a data base storing the data for certifying the validity of the printing apparatus 7, and stores the security certificate 766 issued to the printing apparatus 7 in a retrievable state.

When the control unit 50 receives the registration information 780 including the apparatus' own peculiar information 761 and the installation place information 765 from the printing apparatus 7, the control unit 50 requests the judgment of the validity of the apparatus' own peculiar information 761 included in the registration information 780 from the manufacturer's server 6. When the apparatus' own peculiar information 761 is judged to be just, the control unit 50 produces the security certificate 766 based on the registration information 780.

To put it concretely, the control unit 50 sets the manufacturing company's name 766a, the manufacturing company's ID 766b, the manufacturing number 766c and the apparatus' public key 766d of the security certificate 766 based on the registration information 780, and sets the owner's name 766e, the installation place's address 766f and the network address 766g of the printing apparatus 7 based on the installation place information 765.

Moreover, the control unit 50 issues the unique number of each of the security certificates 766 to set the number as the serial number 766h. Moreover, the control unit 50 sets the issuer's name 766i settled in advance, the effective period 766j calculated from the date of issuing the security certificate 766, and the network address 766k of the authentication server 5.

Then, the control unit 50 sets the hash value 766l calculated from the set data using a predetermined hash function. The control unit 50 produces the digital signature 766m using the secret key of the certificate authority 500, and generates the encrypted security certificate 766.

The control unit 50 stores the security certificate 766 generated in such a way into the security information management DB 530 so as to be retrievable, and the printing server 3 judges whether the security certificate 766 transmitted from the printing apparatus 7 is the just one or not by referring to the security information management DB 530.

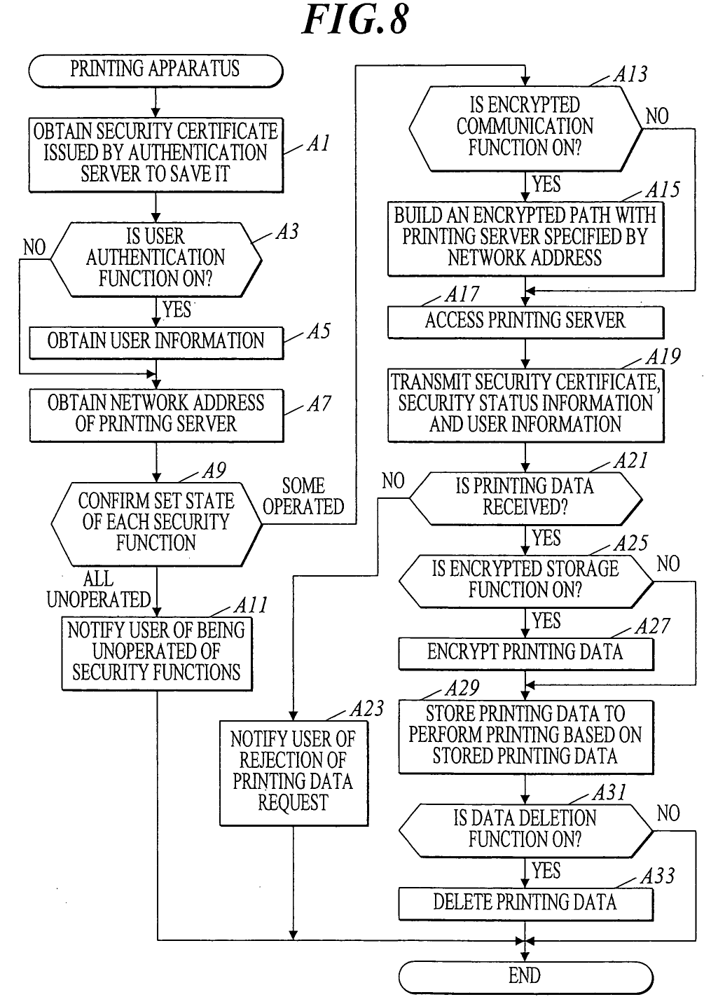

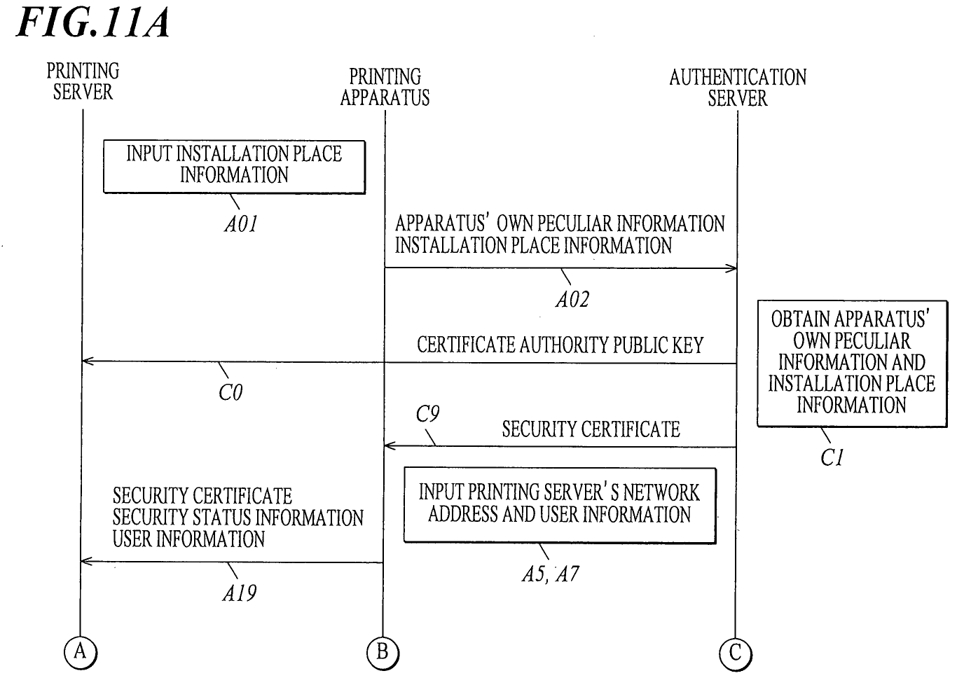

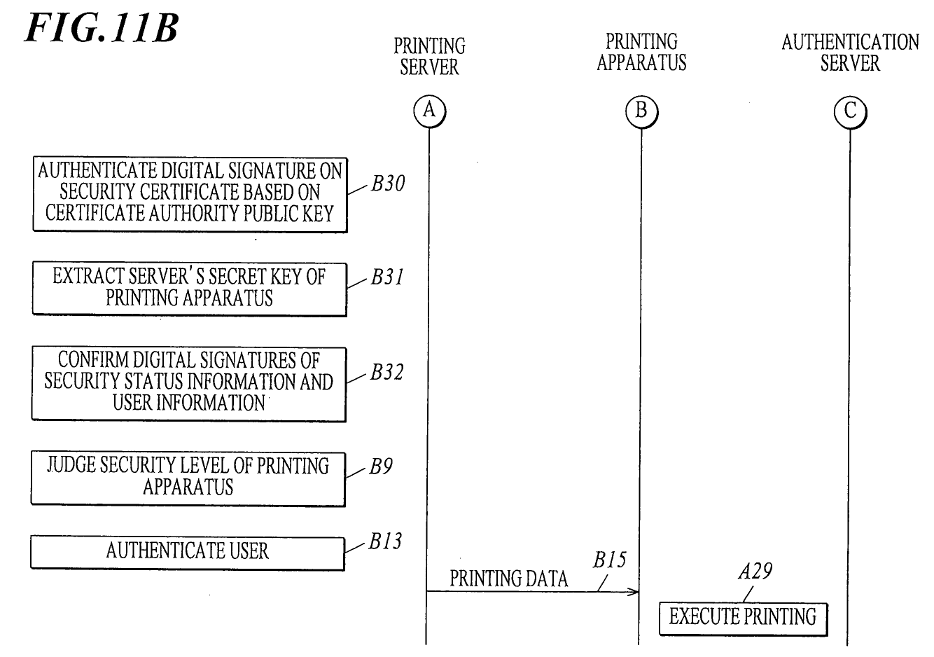

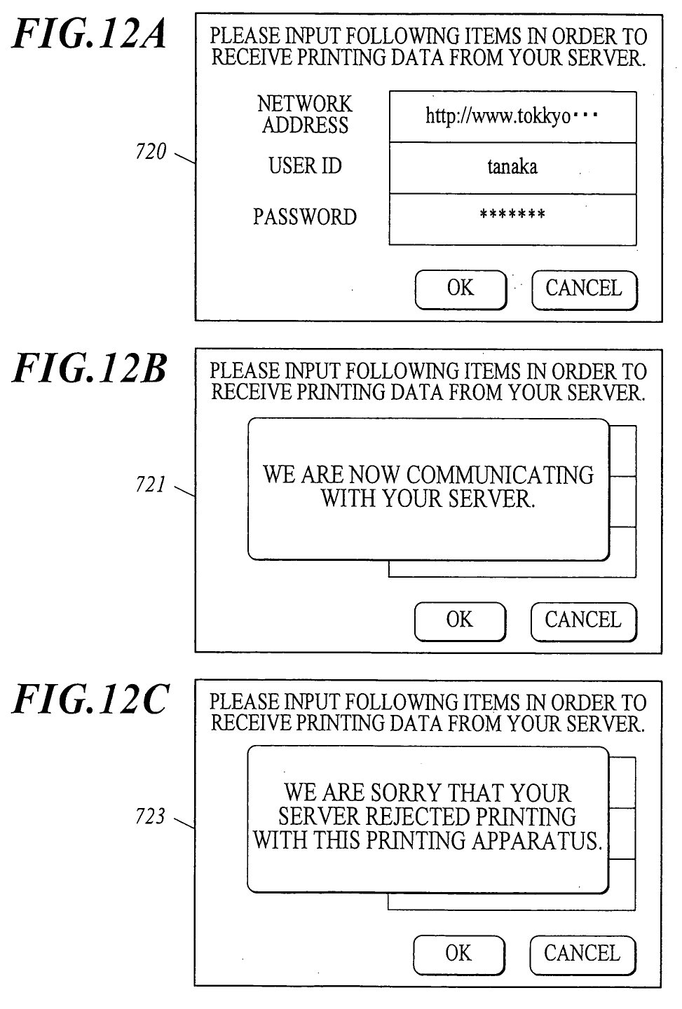

Next, a concrete operation example of the print authentication system S is described with reference to the flow charts of FIGS. 8-10, the communication sequence of FIGS. 11A and 11B, and the display screen examples of FIGS. 12A-12C. First of all, the processing until the security certificate 766 is issued from the authentication server 5, which is performed at the time of the installation of the printing apparatus 7, is described.

At the time of installing the printing apparatus 7, a user (installation dealer) first inputs the installation place information 765 into the printing apparatus 7 with the operation unit 71 (Step A01). Then, the control unit 70 of the printing apparatus 7 accesses the authentication server 5 based on the network address 763 stored in the ROM 760 to transmit the installation place information 765 and the apparatus' own peculiar information 761 to the authentication server 5 through the public network N2 (Step A02).

When the control unit 50 of the authentication server 5 receives the registration information 780 from the printing apparatus 7 (Step C1), the control unit 50 requests the inquiry about the registration information 780 from the manufacturer's server 6 (Step C3). Then, when the authentication of the registration information 780 cannot be obtained (Step C5; No), the control unit 50 notifies the printing apparatus 7 of the stop of the issue of the security certificate 766 (Step C15).

Moreover, when the authentication of the registration information 780 can be obtained (Step C5; Yes), the control unit 50 generates the security certificate 766 as mentioned above (Step C7). The control unit 50 issues the generated security certificate 766 to the printing apparatus 7 by transmitting the security certificate 766 to the printing apparatus 7 (Step C9).

On the other hand, the control unit 70 of the printing apparatus 7 obtains the security certificate 766 issued from the authentication server 5 to store the obtained security certificate 766 into the flash memory 764 (Step A1). In addition, it is preferable to build an encrypted path by a known technique onto the public network N2 as the communication path between the printing apparatus 7 and the authentication server 5. Thereby, it is possible to prevent the alteration and the leakage of the data of the registration information 780 and the security certificate 766.

Next, a description is given to the processing until the downloading of the printing data 331 from the printing server 3 to execute printing. First, the control unit 70 of the printing apparatus 7 judges whether the operating flag of the user authentication function is set to be ON or not based on the security status information 769 (Step A3).

At this time, when the control unit 70 judges that the operating flag is set to be ON (Step A3; Yes), the control unit 70 makes the display unit 72 display a display screen 720 as shown in FIG. 12A to urge the user to input the user ID and the password, and obtains them based on operation signals from the operation unit 71 (Step A5). Then, the control unit 70 obtains the network address of the printing server 3 input by a user's operation (Step A7).

The control unit 70 confirms the operation state of each of the security functions based on the security status information 769. When the control unit 70 judges that the operating flags of all of the security functions are set to be OFF and all of them are unoperated (Step A9; all being unoperated), the control unit 70 notifies the user of the fact of being unoperated by making the display unit 72 display the fact (Step A11).

Moreover, when the control unit 70 judges that the operating flag of any one of the security functions is set to be ON and there is a security function set to be operated (Step A9; some operated), the control unit 70 judges whether the operating flag of the encrypted communication function is set to be ON or not (Step A13). Then, when the operating flag is set to be ON (Step A13; Yes), the control unit 70 builds an encrypted path with the external equipment specified by the network address 768 (Step A15), and accesses the printing server 3.

Moreover, when the operating flag is not set to be ON (Step A13; No), the control unit 70 accesses the printing server 3 as it is (Step A17). After accessing the printing server 3, the control unit 70 transmits the security certificate 766, the security status information 769 and the user information 767 to the printing server 3 (Step A19), and waits the reception of the printing data 331.

On the other hand, when the control unit 30 of the printing server 3 receives the security certificate 766, the security status information 769 and the user information 767 from the printing apparatus 7 (Step B3), the control unit 30 obtains the certificate authority public key 332 from the authentication server 5 in advance (Step C0), and then performs the authentication of the digital signature 766m of the security certificate 766 using the certificate authority public key 332 (Step B30). It is possible to confirm whether the security certificate 766 is one having been issued from the authentication server 5 or not by means of the authentication of the digital signature 766m.

Then, when the control unit 30 has obtained the authentication of the digital signature 766m, the control unit 30 judges whether the network address of the printing apparatus 7, which is the communication party, and the network address 766g of the printing apparatus 7 included in the security certificate 766 agree with each other or not. When the control unit 30 judges that they agree with each other, it can be judged that the identity of the printing apparatus 7 is guaranteed by the authentication server 5.

Moreover, the control unit 30 extracts the apparatus' public key 766d in the security certificate 766 (Step B31), and performs the authentication of the digital signatures 769e and 767c of the security status information 769 and the user information 767 by means of the apparatus' public key 766d (Step B32).

Then, when the control unit 30 can obtain the authentication, the control unit 30 calculates a hash value from the security certificate 766 using a predetermined hash function, and judges whether the calculated hash value and the hash value 766l included in the security certificate 766 agree with each other or not. At this time, when the calculated hash vale agrees with the hash value 766l, it can be judged that the security certificate 766 has not been altered by communications through the public network N2.

Next, the control unit 30 transmits the security certificate 766 to the authentication server 5 to ask the inquiry about the security certificate 766 (Step B5). At this time, when the control unit 50 of the authentication server 5 accepts the ask of the inquiry about the security certificate 766 from the printing server 3 (Step C11), the control unit 50 judges the validity of the security certificate 766 by comparing the security certificate 766 with the security certificate stored in a security information management DB 530. Then, the control unit 50 transmits the result of the inquiry about whether the security certificates agree with each other or not to the printing server 3 (Step C13).

The control unit 30 of the printing server 3 judges whether the authentication of the security certificate 766 has been OK or not based on the inquiry result transmitted from the authentication server 5. When the authentication is OK (Step B7; Yes), the control unit 30 judges the security level of the printing apparatus 7 based on the security status information 769 (Step B9). The judging method is the one as mentioned above. That is, it is judged whether the operation setting of each of the security functions and the detailed settings satisfy the predetermined conditions or not. When the settings satisfy the predetermined condition, it is judged that the security level of the printing apparatus 7 is standard or more (Step B11; Yes).

Then, the control unit 30 performs the user authentication by comparing the user information 767 with the user information DB 330 (Step B13). When the control unit 30 judges that the user is the registered user (Step B13; Yes), the control unit 30 transmits the printing data 331 to the printing apparatus 7 (Step B15). On the other hand, when the authentication of the security certificate 766 cannot be obtained (Step B7; No), when the security level is less than the standard (Step B11; No), and when the user authentication cannot be obtained (Step B13; No), the control unit 30 transmits the rejection notice the printing apparatus 7 of the impossibility of the transmission of the printing data 331 (Step B17).

After the transmission of the security certificate 766, the security status information 769 and the user information 767 to the printing server 3 at the Step A19, the control unit 70 of the printing apparatus 7 makes the display unit 72 display a display screen 721 as shown in FIG. 12B, and waits the reception of the printing data 331 from the printing server 3.

Then, when the control unit 70 receives a notice of the rejection of the transmission of the printing data 331 without receiving the printing data 331 (Step A21; No), the control unit 70 makes the display unit 72 display a display screen 723 as shown in FIG. 12C, and notifies the user of the rejection of the request of the printing data 331 (Step A23).

Moreover, when the control unit 70 receives the packet of the printing data 331 from the printing server 3 (Step A21; Yes), the control unit 70 judges whether the operating flag of the encrypted storage function is ON or not based on the security status information 769 (Step A25). When the operating flag is ON (Step A25; Yes), the control unit 70 encrypts each packet of the printing data 331 by the encryption system settled by the detailed setting information of the security status information 769 (Step A27). Thereby, the leakage of the printing data 331 when the storage unit 76 is removed to the outside of the printing apparatus 7 is prevented.

Then, the control unit 70 temporarily stores the printing data 331 into the image memory 770 (Step A29), and performs the image formation based on the printing data 331 (Step A29). In addition, when the printing data 331 has been encrypted at the Step A27 at the time of reading the printing data 331 from the image memory 770, it is necessary to decode the printing data 331 with a predetermined decode key.

Next, after the image formation, the control unit 70 judges whether the operating flag of the data deletion function is ON or not based on the security status information 769 (Step A31). When the operating flag is ON (Step A31; Yes), the control unit 70 overwrites other data such as invalid data on the data region of the image memory 770 recording the printing data 331 to delete the printing data 331 completely (Step A33). Then, the control unit 70 ends the processing shown in FIG. 8.

As mentioned above, according to the embodiment described above, the printing server 3 obtains the security status information 769 stored in the printing apparatus 7, and judges the operation state of each of the security functions based on the security status information 769. The printing server 3 transmits the printing data 331 only when the operation state satisfies the predetermined condition.

Thereby, when the security status information 769 does not satisfy the predetermined condition because the setting of each of the security functions of the printing apparatus 7 has been changed by, for example, an illegal operation, an illegal access or the like, the transmission of the printing data 331 is stopped. Consequently, it becomes possible to transmit the printing data 331 to the printing apparatus 7 having a desired security level, and the leakage, the alteration and the like of information can be prevented without performing the registration of the printing apparatus 7 on the side of the printing server 3. Consequently, the guarantee of the safety of the printing apparatus 7 at the time of the transmission of the printing data 331 can be surely performed.

Moreover, at the time of the installation of the printing apparatus 7, the printing apparatus 7 accesses the authentication server 5 based on the network address 763 stored in the ROM 760, and transmits the registration information 780 including the apparatus' own peculiar information 761 and the installation place information 765 to the authentication server 5. Thereby, the printing apparatus 7 receives the security certificate 766 from the authentication server 5 to store it in the flash memory 764. Consequently, at the time of the installation of the printing apparatus 7, the user such as the installation dealer or the like can download the security certificate 766 from the authentication server 5 to the printing apparatus 7 by a simple operation of inputting the information at the time of the installation into the printing apparatus 7.

Moreover, because the authentication server 5 inquires of the manufacturer's server 6 about the validity of the registration information 780 transmitted from the printing apparatus 7 before issuing the security certificate 766, it can be prevented to issue the security certificate 766 to a counterfeit good or an unjustly remodeled printing apparatus. Consequently, it is possible to decrease troublesome operations necessary to issue the security certificate 766 for the guarantee of the safety of the printing apparatus 7.

In addition, the embodiment mentioned above is only an example of the application of the present invention, and the applicable scope of the present invention is not limited to the aforesaid one. For example, although the user information such as a user ID and a password has been described to be input into the printing apparatus 7 by a user's manual input, or wireless communication or infrared ray communication from the portable terminal 8, the user information may be obtained by being stored into, for example, an IC card building a radio frequency identification (RFID) tag therein and by the transmission of an electromagnetic wave from the side of the printing apparatus 7 to the RFID tag.

Moreover, the user information may be obtained by converting the user information into code information such as a QR code, a bar code or the like in advance to be stored in the portable terminal 8, and by photographing the code information with a photographing apparatus (not shown) that is equipped into the printing apparatus 7 and includes a CCD or a CMOS sensor to decode the code.

As described above, a known technique can be suitably adopted as the method of inputting the user information into the printing apparatus 7, and the labor of the user's input operation can be saved.

Moreover, a known technique can be suitably adopted as the method of user authentication, and, for example, the user authentication based on fingerprint authentication or voice print authentication may be performed. In the case of performing the finger print authentication, a fingerprint sensor is provided on the printing apparatus 7, and the fingerprint image extracted from the tip of a finger of the user and the user ID are obtained as the user information. In addition, the fingerprint image may be previously registered in the portable terminal 8, and the fingerprint may be transmitted to the printing apparatus 7 by wireless communication or infrared ray communication.

According to the embodiment, when the image formation apparatus transmits the registration information including individual information and installation information to the authentication server indicated by the connection destination information stored in a storage unit, the authentication server generates security certification information to transmit the generated security certification information to the image formation apparatus. Consequently, at the time of installing the image formation apparatus, it is possible to obtain the security certification information from the authentication server by a simple operation of inputting the installation information into the image formation apparatus. Consequently, it is possible to decrease troublesome operations necessary for issuing the security certification information for the guarantee of the safety of the image formation apparatus.

Moreover, authentication server may be configured to generate the security certification information when validity is obtained as a result of a request of judgment by requesting the judgment of the validity pertaining to at least a part of the information included in the registration information from a manufacturer's server. Consequently, it can be prevented to issue the security certification information to a counterfeit good and an unjustly remodeled image formation apparatus.

Further, a hash value and the manufacturer information, the positional information, the manufacturing number and the key information of the image formation apparatus may be included in the security certification information. Thereby, security certification information different to each image formation apparatus can be issued.

What is claimed is:

1. An authentication server communicationally connected to an image formation apparatus through a communication network, comprising:
a registration information reception unit to receive registration information including individual information assigned peculiarly to the image formation apparatus and installation information from the image formation apparatus;
a security information generation unit to generate security certification information based on the registration information received by the registration information reception unit; and
a security information transmission unit to transmit the security certification information generated by the security information generation unit to the image formation apparatus.

2. The authentication server of claim 1, further comprising a judgment request unit to request judgment of validity pertaining to at least a part of information included in the registration information from a manufacturer's server of the image formation apparatus, wherein
the security information generation unit generates the security certification information when the validity of at least a part of information included in the registration information can be obtained as a result of the request of judgment by the judgment request unit.

3. The authentication server of claim 1, wherein the security information generation unit calculates a hash value based on the registration information to generate the security certification information including the hash value.

4. The authentication server of claim 1, wherein the security information generation unit generates the security certification information including manufacturer information of the image formation apparatus.

5. The authentication server of claim 1, wherein the installation information includes positional information of the image formation apparatus on the communication network.

6. The authentication server of claim 1, wherein the individual information includes a manufacturing number of the image formation apparatus.

7. The authentication server of claim 1, wherein the individual information includes key information issued by a manufacturer's server of the image formation apparatus.

8. An image formation apparatus communicationally connected to external equipment through a communication network, comprising:
a storage unit to previously store connection destination information of an authentication server before shipment of the image formation apparatus;
an input unit to accept an input of installation information of the image formation apparatus by a user's operation;
a registration information transmission unit to transmit individual information peculiar to the image formation apparatus and the installation information as registration information to the authentication server indicated by the connection destination information stored in the storage unit; and
a storage control unit to receive security certification information to the registration information from the authentication server to store the security certification information in the storage unit.

9. The image formation apparatus of claim 8, wherein the security certification information includes a hash value calculated based on the registration information.

10. The image formation apparatus of claim 8, wherein the security certification information includes manufacturer information of the image formation apparatus.

11. The image formation apparatus of claim 8, wherein the installation information includes positional information of the image formation apparatus on the communication network.

12. The image formation apparatus of claim 8, wherein the individual information includes a manufacturing number of the image formation apparatus.

13. The image formation apparatus of claim 8, wherein the individual information includes key information issued by a manufacturer's server of the image formation apparatus.

14. An image formation authenticating system in which an image formation apparatus and an authentication server are communicationally connected with each other through a communication network, wherein
the image formation apparatus includes:
a storage unit to previously store connection destination information of the authentication server before shipment of the image formation apparatus;
an input unit to accept an input of installation information of the image formation apparatus by a user's operation;
a registration information transmission unit to transmit individual information of the image formation apparatus and the installation information as registration information to the authentication server indicated by the connection destination information stored in the storage unit; and
a storage control unit to receive security certification information to the registration information from the authentication server to store the security certification information in the storage unit, and
the authentication server includes:
a registration information reception unit to receive the registration information from the image formation apparatus;
a security information generation unit to generate the security certification information based on the registration information received by the registration information reception unit; and
a security information transmission unit to transmit the security certification information generated by the security information generation unit to the image formation apparatus.

15. The image formation authenticating system of claim 14, wherein
the authentication server further includes a judgment request unit to request judgment of validity pertaining to at least a part of information included in the registration information from a manufacturer's server of the image formation apparatus, and
the security information generation unit generates the security certification information when the validity of at least a part of information included in the registration information can be obtained as a result of the request of judgment by the judgment request unit.

16. The image formation authenticating system of claim 14, wherein the security information generation unit calculates a hash value based on the registration information to generate the security certification information including the hash value.

17. The image formation authenticating system of claim 14, wherein the security information generation unit generates the security certification information including manufacturer information of the image formation apparatus.

18. The image formation authenticating system of claim 14, wherein the installation information includes positional information of the image formation apparatus on the communication network.

19. The image formation authenticating system of claim 14, wherein the individual information includes a manufacturing number of the image formation apparatus.

20. The image formation authenticating system of claim 14, wherein the individual information includes key information issued by a manufacturer's server of the image formation apparatus.

21. A computer readable storage medium storing a program for making a computer function as:
a registration information reception unit to receive registration information including individual information assigned peculiarly to an image formation apparatus and installation information from the image formation apparatus;
a security information generation unit to generate security certification information based on the registration information received by the registration information reception unit; and
a security information transmission unit to transmit the security certification information generated by the security information generation unit to the image formation apparatus.

22. A computer readable storage medium storing a program for making a computer function as:
a storage unit to previously store connection destination information of an authentication server before shipment of an image formation apparatus;
an input unit to accept an input of installation information of the image formation apparatus by a user's operation;
a registration information transmission unit to transmit individual information peculiar to the image formation apparatus and the installation information as registration information to the authentication server indicated by the connection destination information stored in the storage unit; and
a storage control unit to receive security certification information to the registration information from the authentication server to store the security certification information in the storage unit.
